(19) United States
(12) Patent Application Publication
(10) Pub. No.: US 2026/0014865 A1
(43) Pub. Date: Jan. 15, 2026

(54) VULNERABLE ROAD USER HIGHLIGHTING ON HYBRID AUGMENTED REALITY HEAD-UP DISPLAYS

(71) Applicant: GM Global Technology Operations LLC, Detroit, MI (US)

(72) Inventors: Thomas A. Seder, Fraser, MI (US); Joseph F. Szczerba, Grand Blanc, MI (US); Kai-Han Chang, Madison Heights, MI (US); Guy N. Kennerly, Southfield, MI (US)

(73) Assignee: GM Global Technology Operations LLC, Detroit, MI (US)

(21) Appl. No.: 18/769,266

(22) Filed: Jul. 10, 2024

(51) Int. Cl. B60K 35/28; B60K 35/23

(52) U.S. Cl. CPC B60K 35/28; B60K 35/23; B60K 2360/177; B60K 2360/178; B60K 2360/21

(57) ABSTRACT

A system and method include receiving sensor data detected by a sensor system of a vehicle, the sensor data including one or more data fragments located outside of a line of sight of a driver of the vehicle, classifying, based on the sensor data, the one or more data fragments as a vulnerable road user, and determining, based on the sensor data, location data of the vulnerable road user. The system and method also include assessing a threat level between the vulnerable road user and the vehicle, and displaying, via head-up displays, a graphical alert alerting the driver of the vehicle to the vulnerable road user, the graphical alert including an augmented reality image overlay and a virtual image, the augmented reality image overlay different from the virtual image.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a system and method of vulnerable road user highlighting on hybrid augmented reality head-up displays. Generally, when a vehicle is moving, its 360-degree sensing system continuously receives sensor data indicative of the vehicle's environment. For example, the sensor data may indicate that the vehicle's environment includes an upcoming vulnerable road user such as a pedestrian, bicyclist, and/or animal. While existing head-up displays are particularly adept at alerting drivers to vulnerable road users within the field of view of a driver (e.g., the driver's view while facing forward), many vulnerable road users are outside of the field of view of the driver. Additionally, as a driver is continually scanning the roadway, bias may impact the driver's threat assessment when identifying and classifying safety risks.

Accordingly, it is of particular importance for driver and pedestrian safety to develop systems that effectively identify and classify vulnerable road users that are outside of the field of view of the driver by combining augmented reality graphics with directional graphics to alert the driver. Moreover, providing these hybrid graphics as alerts using pillar-to-pillar display capabilities may integrate the alerts with the driver's view of the roadway while limiting distractions. Further, providing automatic classification of a vulnerable road user and providing advance notice to a driver of a vehicle offers the driver additional time to take corrective action while minimizing bias in threat assessments.

### SUMMARY

One aspect of the disclosure provides a computer-implemented method for vulnerable road user highlighting on hybrid augmented reality head-up displays that when executed on data processing hardware causes the data processing hardware to perform operations that include receiving sensor data detected by a sensor system of a vehicle, the sensor data including one or more data fragments located outside of a line of sight of a driver of the vehicle, and classifying, based on the sensor data, the one or more data fragments as a vulnerable road user. The operations also include determining, based on the sensor data, location data of the vulnerable road user, assessing a threat level of the vulnerable road user to the vehicle, and displaying, via head-up displays, a graphical alert alerting the driver of the vehicle to the vulnerable road user, the graphical alert including an augmented reality image overlay and a virtual image, the augmented reality image overlay different from the virtual image.

Implementations of the disclosure may include one or more of the following optional features. In some implementations, the head-up displays include an augmented reality head-up display and a blackout head-up display. In these implementations, simultaneously displaying, via the head-up displays, the graphical alert alerting the driver of the vehicle to the vulnerable road user may include generating the augmented reality image overlay, generating the virtual image, and projecting the augmented reality image overlay and the virtual image on a windshield of the vehicle simultaneously. Projecting the augmented reality image overlay and the virtual image on the windshield of the vehicle simultaneously may include projecting the augmented reality image overlay on a clear portion of the windshield and projecting the virtual image on a blackout portion of the windshield. Additionally or alternatively, projecting the augmented reality image overlay and the virtual image on a windshield of the vehicle simultaneously further includes determining, based on driver features, a location of the windshield that corresponds to a line of sight of the driver, and projecting the augmented reality image overlay on the location of the windshield that corresponds to the line of sight of the driver.

In some examples, the sensor system includes one or more of cameras, a forward collision mitigation system, radio detection and ranging (RADAR), and light detection and ranging (LIDAR). In some implementations, the operations further include receiving vehicle data, calculating, based on the vehicle data, a trajectory of the vehicle and a distance between the vehicle and the vulnerable road user, and determining whether the vulnerable road user and the vehicle will interact. In these implementations, assessing the threat level between the vulnerable road user and the vehicle may further include determining, based on the distance between the vehicle and the vulnerable road user and the trajectory of the vehicle, the threat level between the vulnerable road user and the vehicle, and generating the graphical alert based on the threat level between the vulnerable road user and the vehicle.

In some examples, displaying, via the head-up displays, the graphical alert alerting the driver of the vehicle to the vulnerable road user includes displaying the graphical alert on a windshield of the vehicle to indicate a location of the vulnerable road user. In some implementations, classifying, based on the sensor data, the one or more data fragments as the vulnerable road user includes classifying, using a large language model, the one or more data fragments as the vulnerable road user.

Another aspect of the disclosure provides a system for vulnerable road user highlighting on hybrid augmented reality head-up displays that includes data processing hardware and memory hardware in communication with the data processing hardware. The memory hardware stores instructions that when executed by the data processing hardware cause the data processing hardware to perform operations that include receiving sensor data detected by a sensor system of a vehicle, the sensor data including one or more data fragments located outside of a line of sight of a driver of the vehicle, and classifying, based on the sensor data, the one or more data fragments as a vulnerable road user. The operations also include determining, based on the sensor data, location data of the vulnerable road user, assessing a threat level of the vulnerable road user to the vehicle, and displaying, via head-up displays, a graphical alert alerting the driver of the vehicle to the vulnerable road user, the graphical alert including an augmented reality image overlay and a virtual image, the augmented reality image overlay different from the virtual image.

This aspect may include one or more of the following optional features. In some implementations, the head-up displays include an augmented reality head-up display and a blackout head-up display. In these implementations, simultaneously displaying, via the head-up displays, the graphical alert alerting the driver of the vehicle to the vulnerable road user may include generating the augmented reality image overlay, generating the virtual image, and projecting the augmented reality image overlay and the virtual image on a windshield of the vehicle simultaneously. Projecting the augmented reality image overlay and the virtual image on the windshield of the vehicle simultaneously may include projecting the augmented reality image overlay on a clear portion of the windshield and projecting the virtual image on a blackout portion of the windshield. Additionally or alternatively, projecting the augmented reality image overlay and the virtual image on a windshield of the vehicle simultaneously further includes determining, based on driver features, a location of the windshield that corresponds to a line of sight of the driver, and projecting the augmented reality image overlay on the location of the windshield that corresponds to the line of sight of the driver.

In some examples, the sensor system includes one or more of cameras, a forward collision mitigation system, radio detection and ranging (RADAR), and light detection and ranging (LIDAR). In some implementations, the operations further include receiving vehicle data, calculating, based on the vehicle data, a trajectory of the vehicle and a distance between the vehicle and the vulnerable road user, and determining whether the vulnerable road user and the vehicle will interact. In these implementations, assessing the threat level between the vulnerable road user and the vehicle may further include determining, based on the distance between the vehicle and the vulnerable road user and the trajectory of the vehicle, the threat level between the vulnerable road user and the vehicle, and generating the graphical alert based on the threat level between the vulnerable road user and the vehicle.

In some examples, displaying, via the head-up displays, the graphical alert alerting the driver of the vehicle to the vulnerable road user includes displaying the graphical alert on a windshield of the vehicle to indicate a location of the vulnerable road user. In some implementations, classifying, based on the sensor data, the one or more data fragments as the vulnerable road user includes classifying, using a large language model, the one or more data fragments as the vulnerable road user.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a schematic view of an example system for vulnerable road user highlighting on hybrid augmented reality head-up displays.

FIG. 2 is a schematic view of example components of the system of FIG. 1.

FIG. 3 is a vulnerable road user model flowchart for the system of FIG. 1.

FIG. 4 is a schematic view of head-up displays of the system of FIG. 1.

FIG. 5 is a schematic view of head-up displays of the system of FIG. 1.

FIG. 6 is a schematic view of head-up displays of the system of FIG. 1.

FIG. 7 is a flowchart of an example arrangement of operations for a method for vulnerable road user highlighting on hybrid augmented reality head-up displays.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or road hazards. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or road hazard-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

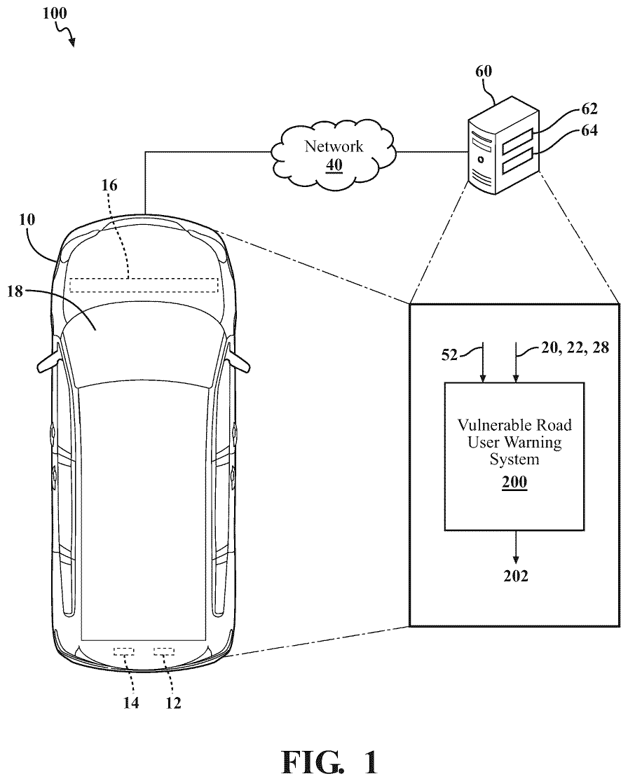

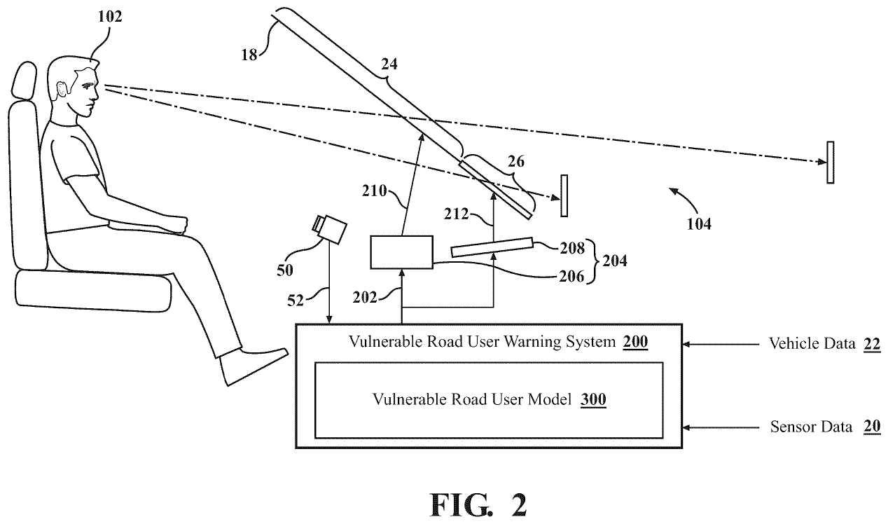

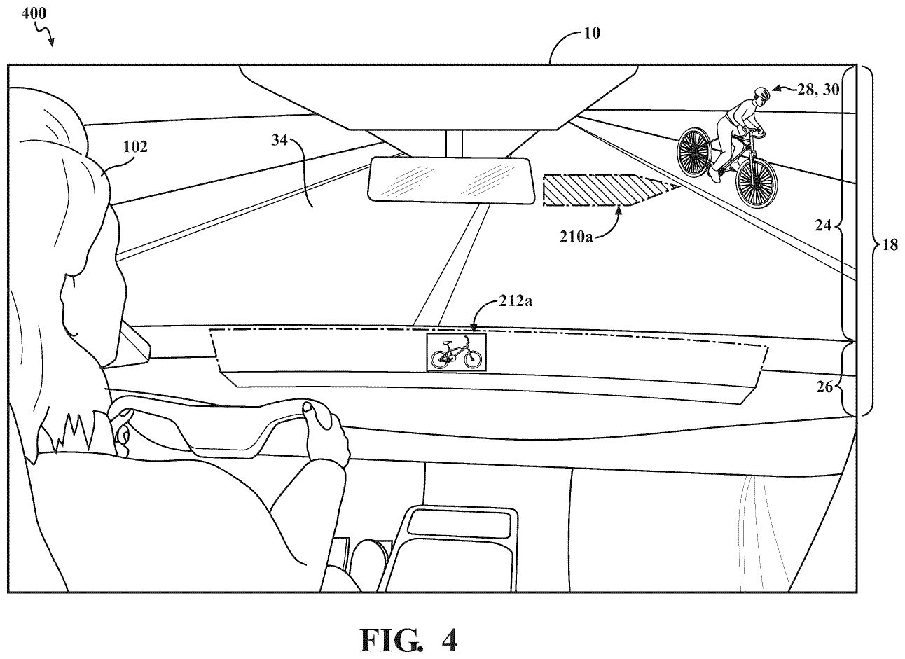

Referring to FIG. 1, in some implementations, a system 100 includes a vehicle 10 and/or a remote system 60 in communication with the vehicle 10 via a network 40. The vehicle 10 and/or the remote system 60 execute a vulnerable road user warning system 200 (FIG. 2), and may be driving on a roadway 34 (FIGS. 4-6). Briefly, and as described in further detail below, the vulnerable road user warning system 200 is configured to receive sensor data 20 including one or more data fragments 28 located outside of a line of sight 104 of a driver 102 of the vehicle 10, and, when the vulnerable road user warning system 200 classifies the one or more data fragments 28 as a vulnerable road user 30, display, via head-up displays 204, a graphical alert 202 alerting the driver 102 to the vulnerable road user 30. Notably, by alerting the driver 102 to the vulnerable road user 30 that is outside of the line of sight 104 of the driver 102, the driver 102 is given time to take corrective action to either slow down, stop, and/or perform evasive maneuvers that would otherwise not be seen by the driver 102. For example, vulnerable road users 30 that are outside the line of sight 104 of the driver 102 may include pedestrians, bicyclists, and/or animals that are vulnerable to the vehicle 10. Moreover, the graphical alerts 202 generated by the vulnerable road user warning system 200 may provide additional situational awareness in automated driving modes that increases user trust and aids in vehicle take-over.

As used herein, a vulnerable road user 30 that is located outside of the line of sight 104 of the driver 102 may generally refer to the positioning of the vulnerable road user 30 with respect to the vehicle 10 in real time, such that a vehicle occupant (e.g., the driver 102) cannot perceive the vulnerable road user 30 when the vehicle occupant is facing toward the front of the vehicle 10. Perception of the vulnerable road user 30 may be based, at least in part, on where the vehicle occupant is sitting inside the vehicle 10, and includes areas outside the vehicle 10 that are not naturally observable when the vehicle occupant's head is facing toward the front of the vehicle 10 such as, for example, the shoulder of the roadway 34. These areas may also include areas outside of the vehicle 10 that are not naturally observable when the vehicle occupant's head turns from the neck to the right and to the left. An example of the line of sight 104 of the driver 102 is shown in FIG. 2, where the dotted arrows bound the line of sight 104, and where vulnerable road user 30 located within the line of sight 104 are perceivable by the driver 102 when the driver 102 is facing toward the front of the vehicle 10. In some implementations, the line of sight 104 is a conical area in the direction of motion of the vehicle 10 ahead of the vehicle with a 120-degree field of view. The line of sight 104 may further extend roughly 800 meters in distance from the driver 102. In other implementations, the line of sight 104 is dynamic based on the geographic region and weather in which the vehicle 10 is driving.

In the examples shown, the vulnerable road user warning system 200 is implemented within a vehicle 10. However, the vulnerable road user warning system 200 can be implemented on other computing devices (e.g., computing devices in communication with the vehicle 10), such as, without limitation, a smart phone, tablet, smart display, desktop/laptop, smart watch, smart appliance, or smart glasses/headset. The vehicle 10 includes data processing hardware 12 and memory hardware 14 storing instructions that when executed on the data processing hardware 12 cause the data processing hardware 12 to perform operations. Additionally, the vehicle 10 includes a driver tracker system 50 configured to capture the eye positioning of the driver 102 while driving the vehicle 10 and determine the driver features 52 of the driver 102. Here, the driver features 52 may include the eye position, head position, or body position of the driver 102. In particular, the driver tracker system 50 may include a facial imaging camera disposed within the vehicle 10 that continually tracks the eyes of the driver 102 to determine the direction at which the driver's eyes are focused. The facial imaging camera may be configured to take images or video of the face of the driver 102 while driving, and extract the eye position, head position, and/or body position of the driver 102 from the images/video. In other implementations, the driver tracker system 50 includes a sensor (e.g., an optical sensor) configured to determine the movement of the eyes of the driver 102 using light reflected from the cornea of the eye. The driver features 52 may be used to establish the line of sight 104 of the driver 102. In other words, the driver features 52 may indicate where the driver 102 is looking, which, together with the peripheral vision of the driver 102, may form the line of sight 104 of the driver 102.

As shown in FIGS. 1 and 2, the vehicle 10 is configured to receive sensor data 20 detected/captured by a sensor system 16. Here, the sensor data 20 may include one or more data fragments 28 located out of the line of sight 104 of the driver 102. The sensor system 16 may include one or more of cameras, a forward collision mitigation system, radio detection and ranging (RADAR), light detection and ranging (LIDAR) capable of capturing image data, and other external sensors of the vehicle 10. While the sensor system 16 shown in FIG. 1 is disposed on a front side of the vehicle, it should be appreciated that the sensor system 16 may include sensors located throughout the vehicle. For example, the sensor system 16 may provide 360-degree surround sensing of an environment of the vehicle 10.

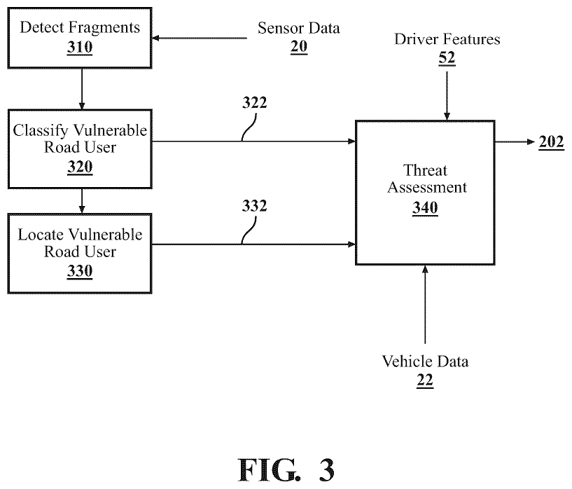

The remote system 60 (e.g., server, cloud computing environment) also includes data processing hardware 62 and memory hardware 64 storing instructions that when executed on the data processing hardware 62 cause the data processing hardware 62 to perform operations. In some examples, execution of the vulnerable road user warning system 200 is shared across the vehicle 10 and the remote system 60. As described in greater detail below with reference to FIGS. 2 and 3, the vulnerable road user warning system 200 executing on the vehicle 10 and/or the remote system 60 executes a vulnerable road user model 300 that is configured to receive the sensor data 20 including the one or more data fragments 28 outside of the line of sight 104 of the driver, and generate the graphical alert 202 alerting the driver 102 when the one or more data fragments 28 correspond to a vulnerable road user 30. Because the one or more data fragments 28 of the sensor data 20 are located outside of the line of sight 104 of the driver 102, the driver 102 may not be aware of the vulnerable road user 30 represented by the one or more data fragments 28.

As shown in FIGS. 1 and 2, the vehicle 10 further includes a windshield 18 providing pillar-to-pillar display capabilities for the vulnerable road user warning system 200. In particular, the windshield 18 includes a clear portion 24 and a blackout portion 26. The clear portion 24 may generally refer to the portion of the windshield 18 through which the driver 102 perceives areas outside the vehicle 10. The blackout portion 26 may generally refer to an opaque or blacked out area of the windshield 18 where an instrument cluster and/or infotainment device may be displayed using one or more of, for example, a vacuum fluorescent display (VFP), a light emitting diode (LED) display, a driver information center display, a radio display, an arbitrary text device, a head-up display (HUD), a touchscreen display, a liquid crystal display (LCD), etc.

Referring to FIGS. 1-3, while the vehicle 10 is moving, the vehicle 10 executes the vulnerable road user model 300 that receives, as input, the sensor data 20 detected by the sensor system 16 of the vehicle 10. The sensor data 20 may include the one or more data fragments 28 and/or additional image data detected by the sensor system 16 and may indicate that the one or more data fragments 28 are moving toward the vehicle 10. The vulnerable road user model 300 may additionally receive vehicle data 22 including a direction of the vehicle 10, a velocity of the vehicle 10, a steering angle of the vehicle 10, an acceleration of the vehicle 10, a braking of the vehicle 10, automated driving system outputs of the vehicle 10, and/or a current location of the vehicle 10. Based on the sensor data 20 and the vehicle data 22, the vulnerable road user warning system 200 executing the vulnerable road user model 300 then generates the graphical alert 202 or disregards (i.e., takes no action on) the sensor data 20.

Referring to FIG. 3, the vulnerable road user model 300 is shown. Here, as the vehicle 10 is moving, the vulnerable road user model 300 continuously receives/processes the sensor data 20 including the one or more data fragments 28 detected by the sensor system 16, the vehicle data 22, and the driver features 52 to determine whether to output the graphical alert 202 to the head-up displays 204. At operation 310, the vulnerable road user model 300 receives the sensor data 20 detected by the sensor system 16 and including the one or more data fragments 28. The vulnerable road user model 300 then classifies, at operation 320, whether any vulnerable road users 30 are detected in the one or more data fragments 28. For example, the vulnerable road user model 300 may include an image classifier such as a large language model configured to receive the one or more data fragments 28 and, identify the one or more data fragments 28 as forming a vulnerable road user 30. For example, the image classifier may process the one or more data fragments 28, and only classify the one or more data fragments 28 as a vulnerable road user 30 when a threshold number of the one or more data fragments 28 correspond to a defined vulnerable road user 30.

In some implementations, at operation 320, the object classifier further generates classification characteristics 322 of the vulnerable road user 30, such as the type of vulnerable road user 30, the responsibility of the vulnerable road user 30, and/or a trajectory assessment of the vulnerable road user 30. The type of vulnerable road user 30 may generally refer to whether the vulnerable road user 30 is an adult, a child, an animal, a pedestrian, a bicyclist, and/or a parked vehicle. The responsibility of the vulnerable road user 30 may generally refer to whether the vulnerable road user 30 is wearing safety gear (e.g., a helmet), making eye contact with the vehicle 10, and/or otherwise distracted. The trajectory assessment of the vulnerable road user 30 generally refers to whether the vulnerable road user 30 is moving into a direct path of the vehicle 10 on the roadway 34, or approaching an unsafe proximity to the vehicle 10. As will be described in greater detail below, the classification characteristics 322 generated by the object classifier of the vulnerable road user model 300 may be used to determine an urgency and/or threat assessment of the vulnerable road user 30.

At operation 330, the vulnerable road user model 300 may generate, based on the sensor data 20 including the one or more data fragments 28, location data 332 of the vulnerable road user 30. For example, the location data 332 may include a location of the vulnerable road user 30, a trajectory of the vulnerable road user 30, and/or a velocity of the vulnerable road user. For example, the location of the vulnerable road user 30 may include on the roadway 34, in a direct path of the vehicle 10, or on a periphery of the roadway 34. The trajectory of the vulnerable road user 30 may include whether the vulnerable road user 30 is approaching the roadway 34 and/or moving alongside the roadway 34.

At operation 340, the vulnerable road user model 300 may assess a threat level between the vulnerable road user 30 and the vehicle 10 and, based on the threat level, generate the graphical alert 202 alerting the driver 102 to the vulnerable road user 30. In particular, the vulnerable road user model 300 receives the classification characteristics 322 of the vulnerable road user 30, the location data 332 of the vulnerable road user 30, the vehicle data 22, and the driver features 52, and performs threat assessment of the vehicle 10 and the vulnerable road user 30 to generate the threat level. For example, a pedestrian that is focused on a mobile device while approaching a crosswalk may include a high threat level (i.e., an enhanced chance of a collision with the vehicle 10), while an adult riding a bicycle on the shoulder of the roadway 34 and wearing a helmet may include a low threat level (i.e., a low chance of collision and/or injury to the vulnerable road user 30). In some implementations, the graphical alert 202 that alerts the driver 102 may be configured based on the threat level. For example, the graphical alert 202 may include different size graphics, shades and brightness of colors (e.g., green, yellow, orange, red, etc.) and/or flashing elements to notify the driver 102 about an approaching vulnerable road user 30 bases on the threat level.

In some examples, determining the threat level includes calculating, based on the vehicle data 22, a trajectory of the vehicle 10 and a distance between the vehicle 10 and the vulnerable road user 30. The trajectory of the vehicle 10 may refer to a position, a direction and/or a velocity of the vehicle based on the current vehicle data 22. For example, the vehicle data 22 may be measured/reported by an inertial measurement unit (IMU). As part of the threat assessment, the vulnerable road user model 300 may determine whether the vehicle 10 and the vulnerable road user 30 will interact. Here, the vehicle 10 may interact with the vulnerable road user 30 by making physical contact (i.e., hitting) the vulnerable road user 30, and/or passing the vulnerable road user 30. The vulnerable road user model 300 may determine that the vehicle 10 may interact with the vulnerable road user 30 by comparing the trajectory of the vehicle 10 and the trajectory of the vulnerable road user 30 and determining whether the respective trajectories will cross or approach one another. In either scenario, the safety of the vulnerable road user 30, the driver 102, the vehicle 10, and any surrounding vehicles and/or pedestrians is significantly improved when the driver 102 is given advance notice (i.e., via the graphical alert 202) of the vulnerable road user 30.

Additionally, the threat assessment may include determining how soon the vehicle 10 and the vulnerable road user 30 will interact. In other words, the vulnerable road user model 300 determines, based on the distance between the vulnerable road user 30 and the vehicle 10 and the trajectory of the vehicle 10, a time to interaction between the vulnerable road user 30 and the vehicle 10, where the vehicle 10 and the vulnerable road user 30 are co-located. In these implementations, the threat level, and therefore the graphical alert 202 may be generated based on the time to interaction between the vulnerable road user 30 and the vehicle 10. In other words, the graphical alert 202 may be configured based on the threat level indicated by the time to interaction between the vulnerable road user 30 and the vehicle 10. Here, the size, prominence, colors, gradient, and/or flashing of the graphical alert 202 may change based on the urgency indicated by the time to interaction between the vulnerable road user 30 and the vehicle 10.

Referring again to FIG. 2, after the vulnerable road user model 300 assesses the threat level between the vulnerable road user 30 and the vehicle 10, the vulnerable road user warning system 200 generates the graphical alert 202. In particular, the vulnerable road user warning system 200 outputs the graphical alert 202 to the head-up displays 204. Here, the graphical alert 202 is further modified/configured based on the driver features 52 (e.g., the eye positioning of the driver 102). In particular, the vulnerable road user warning system 200 generates the graphical alert 202 based on the driver features 52 and a concavity of the windshield 18 of the vehicle 10 to adjust the rendering of the graphical alert 202 on the windshield 18 as the driver 102 scans the roadway 34. Here, when the driver features 52 indicate that the driver 102 is looking in a particular direction, the vulnerable road user warning system 200 may update the xyz positions on the windshield 18 in which the graphical alert 202 is to be projected by the head-up displays 204. For example, when the driver features 52 indicate that the driver 102 is scanning the roadway 34 between right and left (e.g., laterally), the graphical alert 202 may, based on the driver features 52, laterally slide a portion of the graphical alert 202 along the windshield 18. Similarly, when the roadway 34 curves or otherwise changes from straight-line, the driver features 52 may cause the vulnerable road user warning system 200 to shift the graphical alert 202 to align with the eye position of the driver 102 within the line of sight 104 of the driver 102.

As shown, the head-up displays 204 include an augmented reality head-up display 206 and a blackout head-up display 208, where the augmented reality head-up display 206 is configured to project images onto the clear portion 24 of the windshield 18 and the blackout head-up display 208 is configured to project images onto the blackout portion 26 of the windshield 18. The graphical alert 202 may generally include an augmented reality image overlay 210 and a virtual image 212 that are each projected by the respective components of the head-up displays 204. For example, the augmented reality head-up display 206 may receive the graphical alert 202 including the augmented reality image overlay 210, and based on the xyz position determined from the driver features 52, project the augmented reality image overlay 210 onto the clear portion 24 of the windshield 18 in a location on the windshield 18 that corresponds to the line of sight 104 of the driver 102. In some implementations, the augmented reality image overlay 210 indicates a direction of the vulnerable road user 30. Similarly, the blackout head-up display 208 may be configured to display images on the blackout portion 26 of the windshield 18. In particular, the blackout head-up display 208 may receive the graphical alert 202 including the virtual image 212 and project the virtual image 212 onto the blackout portion 26 of the windshield 18, where the virtual image 212 is aligned laterally along the blackout portion 26 with the vulnerable road user 30 on the roadway 34. In some implementations, the augmented reality image overlay 210 and the virtual image 212 are projected onto the windshield 18 simultaneously.

Referring to FIGS. 4-6, example components 400-600 are shown and include the vehicle 10 executing the vulnerable road user warning system 200 to alert the driver 102 to the a vulnerable road user 30. By warning the driver 102 (i.e., via the graphical alert 202), the driver 102 is given additional time to react to/avoid the vulnerable road user 30. As described above, it should be appreciated that the graphical alert 202 projected onto the windshield 18 may be configured/modified base on the assessed threat level between the vulnerable road user 30 and the vehicle 10. For example, the graphical alert 202 may employ images in varying sizes, colors, and/or use other alert techniques to capture the attention of the driver 102 without pulling the attention of the driver 102 from the road. Notably, the augmented reality image overlay 210 and the virtual image 212 may be projected onto the windshield simultaneously, and the augmented reality image overlay 210 may be different from the virtual image 212.

With reference to FIG. 4, the vulnerable road user warning system 200 may detect, based on sensor data 20 including one or more data fragments 28, that a vulnerable road user 30 is located on the shoulder of the roadway 34 (i.e., outside the line of sight 104 of the driver 102). For example, the vulnerable road user 30 may include the classification characteristics 322 of an adult wearing a helmet while riding a bicycle on the shoulder of the roadway 34. Additionally the location data 332 may indicate that the vulnerable road user 30 is traveling alongside the side of the roadway 34 and is unlikely to cross into the path of the vehicle 10. In response to detecting the vulnerable road user 30, the vulnerable road user warning system 200 may assesses the threat level between the vulnerable road user 30 and the vehicle 10 as a medium threat. Thereafter, based on the medium threat level and the driver features 52 detected by the driver tracker system 50, the vulnerable road user warning system 200 generates the graphical alert 202 including an augmented reality image overlay 210a and a virtual image 212a.

As shown, the augmented reality image overlay 210a is projected onto the clear portion 24 of the windshield 18 in a location on the windshield 18 within the line of sight 104 of the driver 102 such that the augmented reality image overlay 210a appears to be positioned on the roadway 34 in front of the vehicle 10, and includes a large arrow alerting the driver 102 to the vulnerable road user 30 on the right side of the vehicle 10. Based on the medium threat level, the augmented reality image overlay 210a including the large arrow may be shaded a warning color (e.g., orange). However, the augmented reality image overlay 210a may include different colors, sizes, or gradients based the medium threat level between the vulnerable road user 30 and the vehicle 10. Simultaneously, the virtual image 212a is projected onto the blackout portion 26 of the windshield 18 to indicate the vulnerable road user 30. As shown, the virtual image 212a includes a graphic of a bicycle to signify the vulnerable road user 30. Like the augmented reality image overlay 210a, the virtual image 212a may be shaded a warning color (e.g., orange), or any other color (e.g., red, yellow, green), size, or gradient based the medium threat level between the vulnerable road user 30 and the vehicle 10.

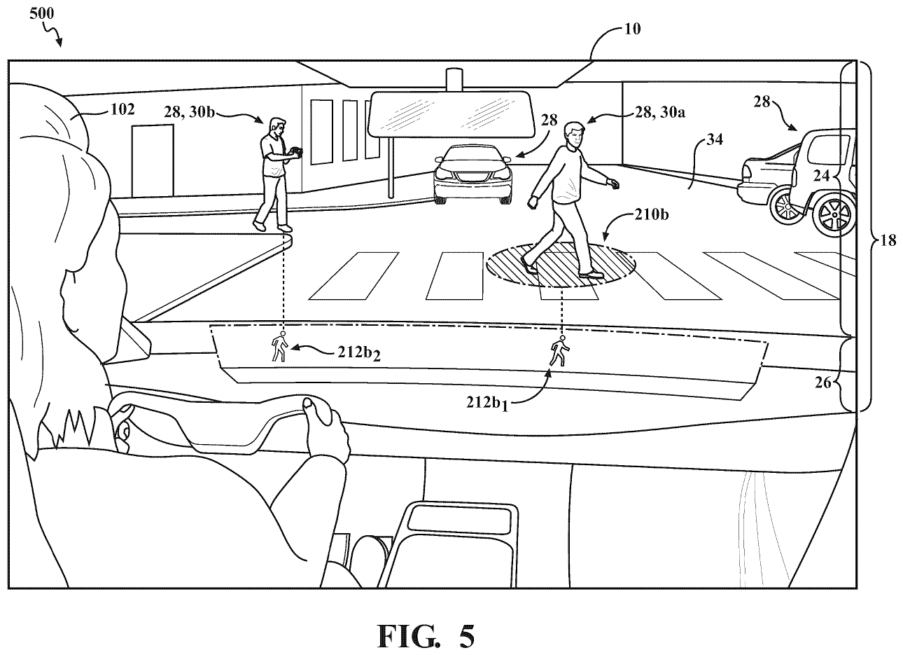

With reference to FIG. 5, the vulnerable road user warning system 200 may detect, based on sensor data 20 including one or more data fragments 28, that vulnerable road users 30a, 30b are located near a crosswalk of the roadway 34. Here, the driver 102 of the vehicle 10 may be in the middle of making a left hand turn into the street the vulnerable road users 30a, 30b are located, such that the vulnerable road users 30a, 30b are outside the line of sight 104 of the driver 102. In this example, the vulnerable road user 30a may include the classification characteristics 322 of an adult pedestrian making eye contact with the vehicle 10. Additionally the location data 332 may indicate that the vulnerable road user 30a is crossing the roadway 34, and the trajectory of the vulnerable road user 30a will cross the trajectory of the vehicle 10. Based on the classification characteristics 322 and the location data 332, the vulnerable road user warning system 200 may assesses the threat level between the vulnerable road user 30a and the vehicle 10 as a high threat level. Conversely, the vulnerable road user 30b may include the classification characteristics 322 of an adult pedestrian looking at a mobile device (i.e., not paying attention), but the location data 332 of being on a sidewalk (i.e., not the roadway) and currently stopped. Here, the vulnerable road user warning system 200 may assesses the threat level between the vulnerable road user 30b and the vehicle 10 as a low threat level. Thereafter, based on the high threat level of the vulnerable road user 30a and the low threat level of the vulnerable road user 30b, and the driver features 52 detected by the driver tracker system 50, the vulnerable road user warning system 200 generates the graphical alert 202 including an augmented reality image overlay 210b and virtual images 212b₁, 212b₂.

As shown, the augmented reality image overlay 210b is projected onto the clear portion 24 of the windshield 18 in a location on the windshield 18 within the line of sight 104 of the driver 102 such that the augmented reality image overlay 210b appears to be positioned on the roadway 34 in front of the vehicle 10, and includes a circular platform underneath the vulnerable road user 30b alerting the driver 102 to the vulnerable road user 30 that the driver 102 is turning the vehicle 10 into. Based on the high threat level, the augmented reality image overlay 210b may be shaded an urgent warning color (e.g., red). However, the augmented reality image overlay 210b may include different colors, sizes, or gradients based the medium threat level between the vulnerable road user 30 and the vehicle 10. Because the vulnerable road user 30b has a low threat level, the graphical alert 202 may not include an augmented reality image overlay 210.

At the same time, virtual images 212b₁, 212b₂ are projected onto the blackout portion 26 of the windshield 18 to indicate the vulnerable road users 30a,30b. As shown, the virtual images 212b₁, 212b₂ include a respective graphic of a pedestrian to signify the vulnerable road users 30a, 30b, where each of the virtual images 212b₁, 212b₂ are aligned with its respective vulnerable road user along a longitudinal axis of the blackout portion 26 of the windshield. Like the augmented reality image overlay 210b, the virtual images 212b₁, 212b₂ may include differing colors (e.g., red, orange, yellow, green), sizes, and/or gradients based the threat level between the vulnerable road users 30a, 30b and the vehicle 10. For example, the virtual image 212b₁ may be shaded red to signify the high threat level between the vulnerable road user 30a and the vehicle 10, while the virtual image 212b₂ corresponding to the vulnerable road user 30b may be shaded yellow to signify the low threat level between the vulnerable road user 30b and the vehicle 10.

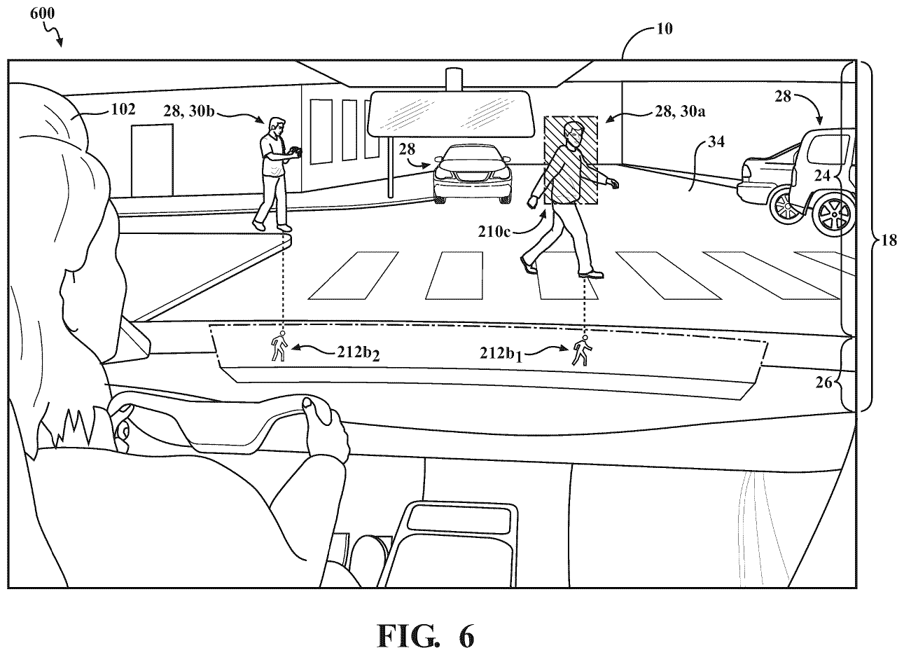

With reference to FIG. 6, as the driver 102 continues driving the vehicle 10 to turn left onto the street the vulnerable road users 30a, 30b are located. Here, the vulnerable road user 30a may enter the line of sight 104 of the driver 102 of the vehicle 10 while the vulnerable road user 30b remains outside of the line of sight 104 of the driver 102. Here, though the vulnerable road user 30a is within the line of sight 104 of the driver 102, the vulnerable road user warning system 200 may still generate the graphical alert 202. For example, the location data 332 of the vulnerable road user 30a may indicate that the vulnerable road user 30a is too close (e.g., within 10 meters) to the vehicle 10 such that a circular platform under the feet of the vulnerable road user 30a will not be visible to the driver 102 despite a high threat level between the vulnerable road user 30a and the vehicle 10. Here, the graphical alert 202 generated by the vulnerable road user warning system 200 may include an augmented reality image overlay 210c.

As shown, the augmented reality image overlay 210c is projected onto the clear portion 24 of the windshield 18 in a location on the windshield 18 within the line of sight 104 of the driver 102 such that the augmented reality image overlay 210c appears to be positioned directly over the vulnerable road user 30a in front of the vehicle 10. Here, the augmented reality image overlay 210c including a box overlaying the vulnerable road user 30a. Based on the high threat level, the augmented reality image overlay 210b may be shaded an urgent warning color (e.g., red). However, the augmented reality image overlay 210b may include different colors, sizes, or gradients based the medium threat level between the vulnerable road user 30a and the vehicle 10.

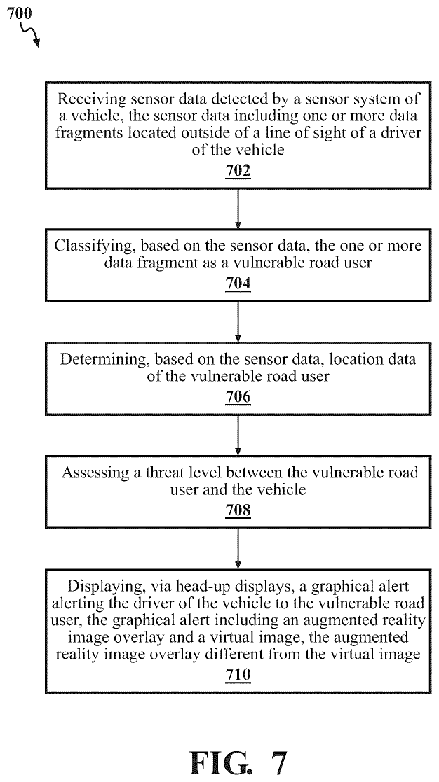

FIG. 7 includes a flowchart of an example arrangement of operations for a method 700 for vulnerable road user highlighting on hybrid augmented reality head-up displays. The method 700 may be described with reference to FIGS. 1-6. Data processing hardware (e.g., data processing hardware 12, 62 of FIG. 1) may execute instructions stored on memory hardware (e.g., memory hardware 14, 64 of FIG. 1) to perform the example arrangement of operations for the method 700.

At operation 702, the method 700 includes receiving sensor data 20 detected by a sensor system 16 of a vehicle 10. The sensor data 20 indicates one or more data fragments 28 located outside of a line of sight 104 of a driver 102 of the vehicle 10. At operation 704, the method 700 also includes classifying, based on the sensor data 20, the one or more data fragments 28 as a vulnerable road user 30. At operation 706, the method 700 further includes determining, based on the sensor data 20, a location of the vulnerable road user 30.

The method 700 also includes, at operation 708, assessing a threat level of the vulnerable road user 30 to the vehicle 10. At operation 710, the method 700 further includes displaying, via head-up displays 204, a graphical alert 202 alerting the driver 102 of the vehicle 10 to the vulnerable road user 30. Here, the graphical alert 202 includes an augmented reality image overlay 210 and a virtual image 212, where the augmented reality image overlay 210 is different from the virtual image 212.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

1. A computer-implemented method when executed on data processing hardware causes the data processing hardware to perform operations comprising:
receiving sensor data detected by a sensor system of a vehicle, the sensor data including one or more data fragments located outside of a line of sight of a driver of the vehicle;
classifying, based on the sensor data, the one or more data fragments as a vulnerable road user;
determining, based on the sensor data, classification characteristics of the vulnerable road user, the classification characteristics including at least one of a specific type of the vulnerable road user or a responsibility level of the vulnerable road user indicating distraction or lack of safety gear;
determining, based on the sensor data, location data of the vulnerable road user;
assessing a threat level of the vulnerable road user to the vehicle based on the classification characteristics and the location data of the vulnerable road user and vehicle data of the vehicle; and
based on the threat level of the vulnerable road user, displaying, via head-up displays, a graphical alert alerting the driver of the vehicle to the vulnerable road user, the graphical alert including an augmented reality image overlay and a virtual image, the augmented reality image overlay different from the virtual image.

2. The method of claim 1, wherein the head-up displays include an augmented reality head-up display and a blackout head-up display.

3. The method of claim 2, wherein simultaneously displaying, via the head-up displays, the graphical alert alerting the driver of the vehicle to the vulnerable road user comprises:
generating the augmented reality image overlay;
generating the virtual image; and
projecting the augmented reality image overlay and the virtual image on a windshield of the vehicle simultaneously.

4. The method of claim 3, wherein projecting the augmented reality image overlay and the virtual image on the windshield of the vehicle simultaneously comprises projecting the augmented reality image overlay on a clear portion of the windshield and projecting the virtual image on a blackout portion of the windshield.

5. The method of claim 3, wherein projecting the augmented reality image overlay and the virtual image on a windshield of the vehicle simultaneously comprises:
determining, based on driver features, a location of the windshield that corresponds to a line of sight of the driver; and
projecting the augmented reality image overlay on the location of the windshield that corresponds to the line of sight of the driver.

6. The method of claim 1, wherein the sensor system comprises one or more of:
cameras;
a forward collision mitigation system;
radio detection and ranging (RADAR); and
light detection and ranging (LIDAR).

7. The method of claim 1, wherein the operations further comprise:
calculating, based on the vehicle data, a trajectory of the vehicle and a distance between the vehicle and the vulnerable road user; and
determining whether the vulnerable road user and the vehicle will interact.

8. The method of claim 7, wherein assessing the threat level between the vulnerable road user and the vehicle comprises:
determining, based on the distance between the vehicle and the vulnerable road user and the trajectory of the vehicle, the threat level between the vulnerable road user and the vehicle; and
generating the graphical alert based on the threat level between the vulnerable road user and the vehicle.

9. The method of claim 1, wherein displaying, via the head-up displays, the graphical alert alerting the driver of the vehicle to the vulnerable road user comprises displaying the graphical alert on a windshield of the vehicle to indicate a location of the vulnerable road user.

10. The method of claim 1, wherein classifying, based on the sensor data, the one or more data fragments as the vulnerable road user comprises classifying, using a large language model, the one or more data fragments as the vulnerable road user.

11. A system comprising:
data processing hardware; and
memory hardware in communication with the data processing hardware, the memory hardware storing instructions that when executed on the data processing hardware cause the data processing hardware to perform operations comprising:
receiving sensor data detected by a sensor system of a vehicle, the sensor data including one or more data fragments located outside of a line of sight of a driver of the vehicle;
classifying, based on the sensor data, the one or more data fragments as a vulnerable road user;
determining, based on the sensor data, classification characteristics of the vulnerable road user, the classification characteristics including at least one of a specific type of the vulnerable road user or a responsibility level of the vulnerable road user indicating distraction or lack of safety gear;
determining, based on the sensor data, location data of the vulnerable road user;
assessing a threat level between the vulnerable road user and the vehicle based on the classification characteristics and the location data of the vulnerable road user and vehicle data of the vehicle; and
based on the threat level of the vulnerable road user, displaying, via head-up displays, a graphical alert alerting the driver of the vehicle to the vulnerable road user, the graphical alert including an augmented reality image overlay and a virtual image, the augmented reality image overlay different from the virtual image.

12. The system of claim 11, wherein the head-up displays include an augmented reality head-up display and a blackout head-up display.

13. The system of claim 12, wherein simultaneously displaying, via the head-up displays, the graphical alert alerting the driver of the vehicle to the vulnerable road user comprises:
generating the augmented reality image overlay;
generating the virtual image; and
projecting the augmented reality image overlay and the virtual image on a windshield of the vehicle simultaneously.

14. The system of claim 13, wherein projecting the augmented reality image overlay and the virtual image on the windshield of the vehicle simultaneously comprises projecting the augmented reality image overlay on a clear portion of the windshield and projecting the virtual image on a blackout portion of the windshield.

15. The system of claim 13, wherein projecting the augmented reality image overlay and the virtual image on a windshield of the vehicle simultaneously comprises:
determining, based on driver features, a location of the windshield that corresponds to a line of sight of the driver; and
projecting the augmented reality image overlay on the location of the windshield that corresponds to the line of sight of the driver.

16. The system of claim 11, wherein the sensor system comprises one or more of:
cameras;
a forward collision mitigation system;
radio detection and ranging (RADAR); and
light detection and ranging (LIDAR).

17. The system of claim 11, wherein the operations further comprise:
calculating, based on the vehicle data, a trajectory of the vehicle and a distance between the vehicle and the vulnerable road user; and
determining whether the vulnerable road user and the vehicle will interact.

18. The system of claim 17, wherein assessing the threat level between the vulnerable road user and the vehicle comprises:
determining, based on the distance between the vehicle and the vulnerable road user and the trajectory of the vehicle, the threat level between the vulnerable road user and the vehicle; and
generating the graphical alert based on the threat level between the vulnerable road user and the vehicle.

19. The system of claim 11, wherein displaying, via the head-up displays, the graphical alert alerting the driver of the vehicle to the vulnerable road user comprises displaying the graphical alert on a windshield of the vehicle to indicate a location of the vulnerable road user.

20. The system of claim 11, wherein classifying, based on the sensor data, the one or more data fragments as the vulnerable road user comprises classifying, using a large language model, the one or more data fragments as the vulnerable road user.
